(19) United States
(12) Patent Application Publication
(10) Pub. No.: US 2022/0038448 A1
(43) Pub. Date: Feb. 3, 2022

(54) SINGLE SIGN-ON USING A MOBILE DEVICE MANAGEMENT ENROLLED DEVICE

(71) Applicant: Citrix Systems, Inc., Ft. Lauderdale, FL (US)

(72) Inventors: Richard John DeFilippo, Coral Springs, FL (US); Raul Planas, Miami, FL (US); Prachee Mhatre, Pompano Beach, FL (US); Padmashri Nonabur Krishnamurthy, North Lauderdale, FL (US)

(73) Assignee: Citrix Systems, Inc., Ft. Lauderdale, FL (US)

(21) Appl. No.: 16/940,487

(22) Filed: Jul. 28, 2020

(51) Int. Cl. H04L 29/06

(52) U.S. Cl. CPC H04L 63/0815; H04L 63/0876; H04L 63/102

(57) ABSTRACT

Systems and methods for providing a single sign-on for authenticating a user via multiple client devices in a distributed resource environment are provided. For example, the system includes a processor that receives a first connection request to a remote resource from an untrusted client device. The processor processes the first connection request to identify an enrolled client device that is configured to authenticate a user of the untrusted client device. The processor further verifies whether a user of the enrolled client device is the user of the untrusted client device and determine if the user of the untrusted client device is authorized to access the remote resource. If the processor determines that the user of the untrusted client device is authorized to access the remote resource, the processor provides the untrusted client device access to the remote resource.

### BACKGROUND

Access to remote resources such as remotely accessible applications generally requires a specific level of security to prevent malicious users from accessing the resources. In many examples, users tend to use a similar set of applications on multiple devices. However, to access an application across multiple platforms, the user may be required to perform a login procedure to authenticate themselves. Each application can follow a different set of password standards and, as the user accesses more applications across varying platforms, it can become challenging for the user to remember what username/password combination corresponds to a particular application. Such a scenario can lead to bad practices on the part of the user such as using the same username/password combination for multiple applications.

### SUMMARY

In at least one example, a computer system for providing a single sign-on for authenticating a user via multiple client devices in a distributed resource environment is provided. The computer system includes a memory, a network interface, and at least one processor coupled to the memory and the network interface. The at least one processor is configured to receive, via the network interface, a first request to connect to a remote resource from an untrusted client device, process the first request to identify an enrolled client device that is configured to authenticate a user of the untrusted client device, verify that a user of the enrolled client device is the user of the untrusted client device, and provide the untrusted client device access to the remote resource.

Implementations of the computer system can include one or more of the following features.

In the computer system, to verify whether the user of the enrolled client device is the user of the untrusted client device can include the at least one processor being further configured to identify mobile device management (MDM) device identification information for the enrolled client device received in the first request, transmit the MDM device identification information to an MDM processor for processing, receive authentication information from the MDM processor, the authentication information comprising information about the user of the enrolled client device, and verify whether a user of the enrolled client device is the user of the untrusted client device based upon the authentication information. In some examples, to verify whether a user of the enrolled client device is the user of the untrusted client device based upon the authentication information can include the at least one processor being further configured to extract user identification information for the user of the enrolled client device from the authentication information, compare the user identification information for the user of the enrolled client device against user identification information for the user of the untrusted client device, and determine if the user identification information for the user of the enrolled client device matches the user identification information for the user of the untrusted client device.

In some examples of the computer system, the computer system can further include the MDM processor, the MDM processor being configured to receive the MDM device identification information from the at least one processor, identify the enrolled client device based upon the MDM device identification information, verify the user of the enrolled client device, and transmit the authentication information to the at least one processor based upon verification of the user of the enrolled client device. In some examples, to verify the user of the enrolled client device can include the MDM processor being further configured to transmit an authentication request to the enrolled client device, receive an authentication response from the enrolled client device, and verify the user of the enrolled client based upon the authentication response. In some examples, the authentication response can be based upon a biometric authentication process of the user of the enrolled client device performed by the enrolled client device.

In the computer system, the first request can include single sign-on information including an identifier of the enrolled client device.

In another example, a method of providing a single sign-on for authenticating a user via multiple client devices in a distributed resource environment is provided. The method includes receiving, by at least one processor, a first request to connect to a remote resource from an untrusted client device; processing, by the at least one processor, the first request to identify an enrolled client device configured to authenticate a user of the untrusted client device; verifying, by the at least one processor, that a user of the enrolled client device is the user of the untrusted client device; and providing, by the at least one processor, the untrusted client device access to the remote resource.

Implementations of the method of providing a single sign-on for authenticating a user via multiple client devices in a distributed resource environment can include one or more of the following features.

In the method, verifying whether the user of the enrolled client device is the user of the untrusted client device can include identifying, by the at least one processor, MDM device identification information for the enrolled client device received in the first request; transmitting, by the at least one processor, the MDM device identification information to an MDM processor for processing; receiving, by the at least one processor, authentication information from the MDM processor comprising information about the user of the enrolled client device; and verifying, by the at least one processor, whether a user of the enrolled client device is the user of the untrusted client device based upon the authentication information. In some examples, verifying whether a user of the enrolled client device is the user of the untrusted client device based upon the authentication information can include extracting, by the at least one processor, user identification information for the user of the enrolled client device from the authentication information; comparing, by the at least one processor, the user identification information for the user of the enrolled client device against user identification information for the user of the untrusted client device; and determining, by the at least one processor, if the user identification information for the user of the enrolled client device matches the user identification information for the user of the untrusted client device.

In some examples of the method, the method can further include receiving, by an MDM processor operably coupled to the at least one processor, the MDM device identification information from the at least one processor; identifying, by the MDM processor, the enrolled client device based upon the MDM device identification information; verifying, by the MDM processor, the user of the enrolled client device; and transmitting, by the MDM processor, the authentication information to the at least one processor based upon verification of the user of the enrolled client device. In some examples, verifying the user of the enrolled client device can include transmitting, by the MDM processor, an authentication request to the enrolled client device; receiving, by the MDM processor, an authentication response from the enrolled client device; and verifying, by the MDM processor, the user of the enrolled client based upon the authentication response. In some examples, the authentication response can be based upon a biometric authentication process of the user of the enrolled client device performed by the enrolled client device.

In the method, the first request can include single sign-on information including an identifier of the enrolled client device.

In another example, a second computer system for providing a single sign-on for authenticating a user via multiple client devices in a distributed resource environment is provided. The second computing system includes an untrusted client device configured to execute a first client agent for authenticating the user of the untrusted client device, an enrolled client device configured to execute a second client agent for authenticating the user of the enrolled client device, and a remote computing device. The remote computing device includes a memory, a network interface configured to communicate with the untrusted client device and the enrolled client device, and at least one processor coupled to the memory and the network interface. The at least one processor is configured to receive a first request to a remote resource from the untrusted client device, process the first request to identify the enrolled client device that is configured to authenticate a user of the untrusted client device, query the enrolled client device to verify whether a user of the enrolled client device is the user of the untrusted client device, and if the user of the untrusted client device is authorized to access the remote resource, provide the untrusted client device access to the remote resource.

Implementations of the second computer system can include one or more of the following features.

In the second computer system, to query the enrolled client device to verify whether a user of the enrolled client device is the user of the untrusted client device can include the at least one processor being further configured to identify MDM device identification information for the enrolled client device received in the first request, transmit the MDM device identification information to an MDM processor for processing, receive authentication information from the MDM processor comprising information about the user of the enrolled client device, and verify whether a user of the enrolled client device is the user of the untrusted client device based upon the authentication information. In some examples, to verify whether a user of the enrolled client device is the user of the untrusted client device based upon the authentication information can include the at least one processor being further configured to extract user identification information for the user of the enrolled client device from the authentication information, compare the user identification information for the user of the enrolled client device against user identification information for the user of the untrusted client device, and determine if the user identification information for the user of the enrolled client device matches the user identification information for the user of the untrusted client device.

In examples of the second computer system, the second computer system can further includes the MDM processor, the MDM processor being configured to receive the MDM device identification information from the at least one processor, identify the enrolled client device based upon the MDM device identification information, verify the user of the enrolled client device, and transmit the authentication information to the at least one processor based upon verification of the user of the enrolled client device. In some examples, to verify the user of the enrolled client device can include the MDM processor being further configured to transmit an authentication request to the enrolled client device, receive an authentication response from the enrolled client device, and verify the user of the enrolled client based upon the authentication response. In some examples, the authentication response can be based upon a biometric authentication process of the user of the enrolled client device performed by the enrolled client device.

Still other aspects, examples and advantages of these aspects and examples, are discussed in detail below. Moreover, it is to be understood that both the foregoing information and the following detailed description are merely illustrative examples of various aspects and features and are intended to provide an overview or framework for understanding the nature and character of the claimed aspects and examples. Any example or feature disclosed herein can be combined with any other example or feature. References to different examples are not necessarily mutually exclusive and are intended to indicate that a particular feature, structure, or characteristic described in connection with the example can be included in at least one example. Thus, terms like “other” and “another” when referring to the examples described herein are not intended to communicate any sort of exclusivity or grouping of features but rather are included to promote readability.

### BRIEF DESCRIPTION OF THE DRAWINGS

Various aspects of at least one example are discussed below with reference to the accompanying figures, which are not intended to be drawn to scale. The figures are included to provide an illustration and a further understanding of the various aspects and are incorporated in and constitute a part of this specification but are not intended as a definition of the limits of any particular example. The drawings, together with the remainder of the specification, serve to explain principles and operations of the described and claimed aspects. In the figures, each identical or nearly identical component that is illustrated in various figures is represented by a like numeral. For purposes of clarity, not every component may be labeled in every figure.

FIG. 1 is a block diagram of a system architecture for accessing a remote computing device by multiple client devices.

FIGS. 2A and 2B illustrate a sample system architecture including multiple client devices connecting to a remote computing device using a single sign-on request, in accordance with at least one example of the present disclosure.

FIG. 3 is a sample sequence diagram for implementing a single sign-on process, in accordance with at least one example of the present disclosure.

FIG. 4A is a flow diagram illustrating an overview of a process implemented by a computing device hosting an enterprise service to facilitate a single sign-on technique, in accordance with at least one example of the present disclosure.

FIG. 4B is a flow diagram illustrating an overview of a process implemented by a mobile device management server to facilitate a single sign-on techniques, in accordance with at least one example of the present disclosure.

FIG. 5 is a flow diagram illustrating an overview of a process implemented by multiple client devices to facilitate a single sign-on technique, in accordance with at least one example of the present disclosure.

FIGS. 6A and 6B are sample user interface screens showing a single sign-on request and confirmation controls, in accordance with at least one example of the present disclosure.

FIG. 7 is a block diagram of an illustrative enterprise mobility management system, in accordance with at least one example of the present disclosure.

FIG. 8 is a block diagram of a computing device that can implement one or more of the computing devices of FIGS. 1, 2A, and/or 2B, in accordance with at least one example of the present disclosure.

### DETAILED DESCRIPTION

As summarized above, various examples described herein are directed to systems and methods for providing a single sign-on technique for authenticating a user of multiple client computing devices. The single sign-on technique uses authentication of a user of a previously enrolled client device to verify that the same user is requesting access to a remote resource on a second, untrusted client device. The single sign-on technique as described herein works to reduce the overall steps required to authenticate the user via both the first (enrolled) client computing device and the second (untrusted) client computing device. These systems and methods overcome drawbacks that arise in other techniques for authenticating users of multiple client computing devices wherein, for example, a user wishing to access remotely located resources via multiple client computing devices is required to perform a full authentication on each client computing device. When using a unique username/password process that includes, for example, a multi-part authentication, authenticating the user on each client computing device can require excessive time and user input. In such an environment, a user may be motivated to use a single client computing device for multiple tasks, even if the client computing device is not well suited or optimized for such tasks.

To improve a user's experience with authentication on multiple client computing devices that belong to or are otherwise assigned to the user, the systems and methods as described herein may include using an enrolled client device through which the user has been previously authenticated. For example, a mobile device management (MDM) server can delegate a portion of the authentication process to the enrolled client device to verify that the user of the enrolled client device is attempting to access remote resources using an untrusted computing device. A remote computing device controls and distributes authentication requests accordingly acting in concert with the MDM processor or server to reduce the overall user involvement and steps taken during verification of the user when accessing one or more remote resources using the untrusted client computing device.

Thus, and in accordance with at least some examples disclosed herein, single sign-on request systems and methods are provided that include improved authentication of a user at multiple client computing devices owned by or otherwise assigned to the same user. These systems and methods enhance the quality of a user's experience by minimizing the time taken to authenticate the user via subsequent client computing devices after authentication and enrollment on a first client computing device.

In some examples, a processor associated with a server included in, for example, a distributed workspace system, can be configured to receive a first connection request to a remote resource from an untrusted client device. The processor can process the first connection request to identify an enrolled client device that is configured to authenticate a user of the untrusted client device. The processor can further verify whether a user of the enrolled client device is the user of the untrusted client device and determine if the user of the untrusted client device is authorized to access the remote resource. If the processor does determine that the user of the untrusted client device is authorized to access the remote resource, the processor can provide the untrusted client device access to the remote resource. In some examples, verifying whether the user of the enrolled client device is the user of the untrusted client device can include transmitting a request to an MDM server or processor for authentication of the user of the enrolled client device. The MDM server can instruct the enrolled client device to verify the user using, for example, a biometric authentication process embedded or otherwise installed on the enrolled client device to verify the user. Such a verification simplifies the authentication process for the user as they are not required to re-enter username/password information on the untrusted client device.

Examples of the methods, systems, and processes discussed herein are not limited in application to the details of construction and the arrangement of components set forth in the following description or illustrated in the accompanying drawings. The methods and systems are capable of implementation in other examples and of being practiced or of being carried out in various ways. Examples of specific implementations are provided herein for illustrative purposes only and are not intended to be limiting. In particular, acts, components, elements and features discussed in connection with any one or more examples are not intended to be excluded from a similar role in any other examples.

### Sample Computing Systems

In some examples, a distributed system is configured to implement workspace and system access to remote users, thereby providing a central repository of applications, files, and other similar resources to a group of trusted users accessible via, for example, an enterprise service. A digital workspace can be implemented as a software framework designed to deliver and manage a user's applications, data, and desktops in a consistent and secure manner, regardless of the user's device or location. Digital workspaces enhance the user experience by streamlining and automating those tasks that a user performs frequently, such as approving expense reports, confirming calendar appointments, submitting helpdesk tickets, and reviewing vacation requests. A digital workspace allows users to access functionality provided by multiple enterprise applications—including “software as a service” (SaaS) applications, web applications, desktop applications, and proprietary applications—through a single interface.

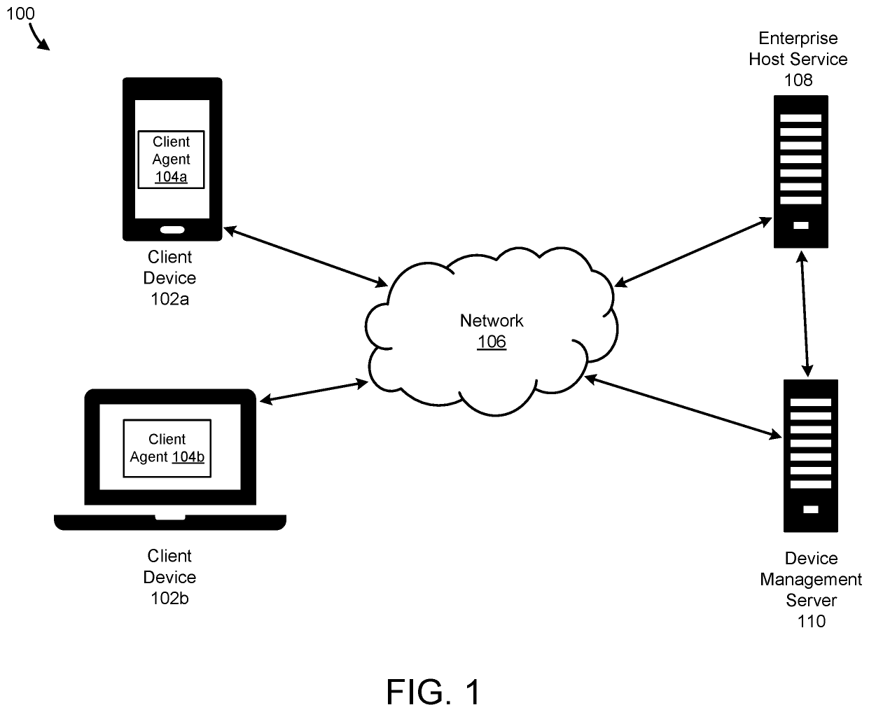

FIG. 1 illustrates a logical architecture of one implementation of, for example, a distributed workspace system 100 that is configured to connect one or more client devices with one or more remote computing devices configured to host shared resources such as applications accessible via the distributed workspace. As shown in FIG. 1, the system 100 can include a client device 102a and a client device 102b. In certain implementations, each of the client devices 102a and 102b can belong to or otherwise be assigned to the same user. For example, as shown in FIG. 1, client device 102a can be a user's cellphone and client device 102b can be the user's laptop computer.

As further shown in FIG. 1, each of client devices 102a and 102b can include a client agent 104a and 104b respectively, herein collectively referred to as client agent 104. Client agent 104 can be configured to provide an interface to facilitate remote access to one or more resources hosted at or by, for example, a remote computing device such as enterprise host service 108 and/or device management server 110. In certain implementations, the client devices 102a and 102b can be operably connected to the remote computing device via one or more networks 106. In some examples, the network 106 can be a wired network, a wireless network, or a combination of both wired and wireless networks.

In some examples, the enterprise host service 108 and/or device management server 110 can execute, operate, or otherwise provide an application that can be any one of the following: software; a program; executable instructions; a virtual machine; a hypervisor; a web browser; a web-based client; a client-server application; a thin-client computing client; an ActiveX control; a Java applet; software related to voice over interne protocol (VoIP) communications like a soft Internet Protocol telephone; an application for streaming video and/or audio; an application for facilitating real-time-data communications; a HyperText Transfer Protocol client; a File Transfer Protocol client; an Oscar client; a Telnet client; or any other set of executable instructions.

In some examples, the enterprise host service 108 and/or device management server 110 can execute a remote presentation services program or other program that uses a thin client or a remote-display protocol to capture display output generated by an application executing on the remote computing device and transmit the application display output to the client devices 102a and 102b for presentation to one or more device users.

In some examples, the enterprise host service 108 and/or device management server 110 can include a server agent that is configured to communicate with the client agent 104. The server agent can be configured to, for example, authenticate a client device, provide secure access to one or more remote and/or shared resources, monitor user interactions with the resources, update user access based upon changes to user permission levels for a client device, distribute or properly direct requests to available resources, and perform other similar distributed workspace functions.

In yet other examples, the enterprise host service 108 and/or device management server 110 can be configured to execute a virtual machine providing, to a user of one of client devices 102a and/or 102b, access to a computing environment. In such an example, the client device 102a and/or 102b can be a virtual machine. The virtual machine can be managed by, for example, a hypervisor, a virtual machine manager (VMM), or any other hardware virtualization technique within the enterprise host service 108 and/or device management server 110.

In some examples, the network 106 can be: a local area network (LAN); a metropolitan area network (MAN); a wide area network (WAN); a primary public network; and a primary private network. Additional examples can include a network 106 of mobile telephone networks that use various protocols to communicate among mobile devices. For short range communications within a wireless local-area network (WLAN), the protocols can include 802.11, Bluetooth, and Near Field Communication (NFC).

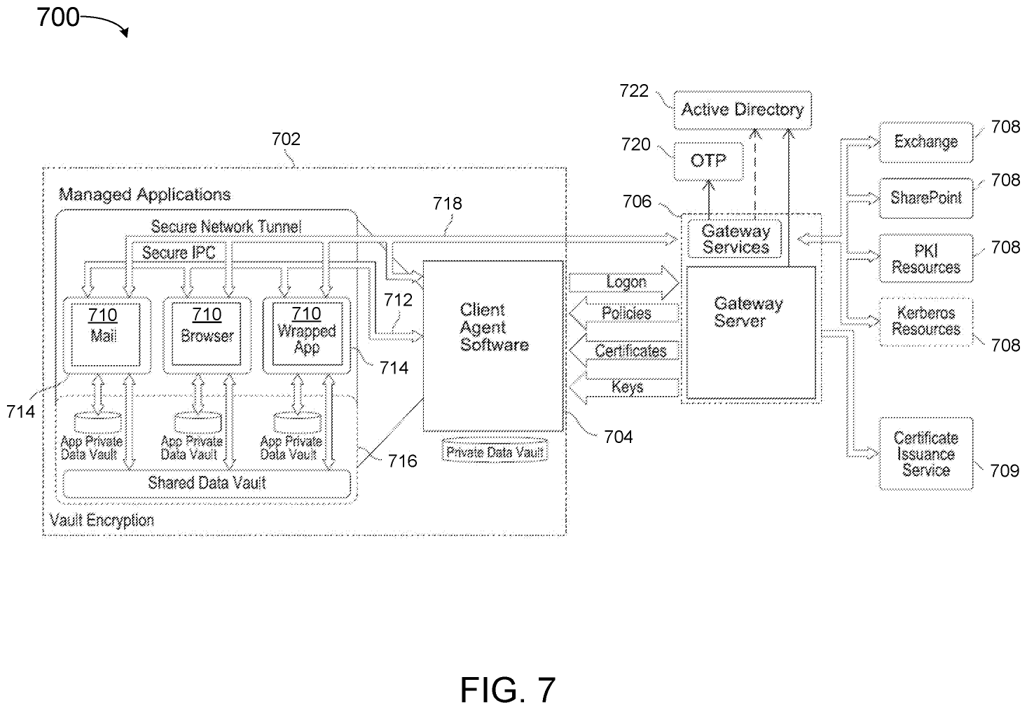

It should be noted that the specific device architecture as shown in FIG. 1 is provided by way of example only. For instance, two client devices 102a and 102b are provided by way of example only and system 100 can include additional client devices. Similarly, the enterprise host service 108 and the device management server 110 are shown as separate remote computing devices by way of example only. In certain implementations, multiple remote computing devices can be operably connected to the client devices via, for example, one or more network appliances configured to perform, for example, access control and load balancing. In other examples, the functionality of both the enterprise host service 108 and the device management server 110 can be implemented in a single remote computing device. An example of such a device is describe in further detail in the discussion of FIG. 7 below.

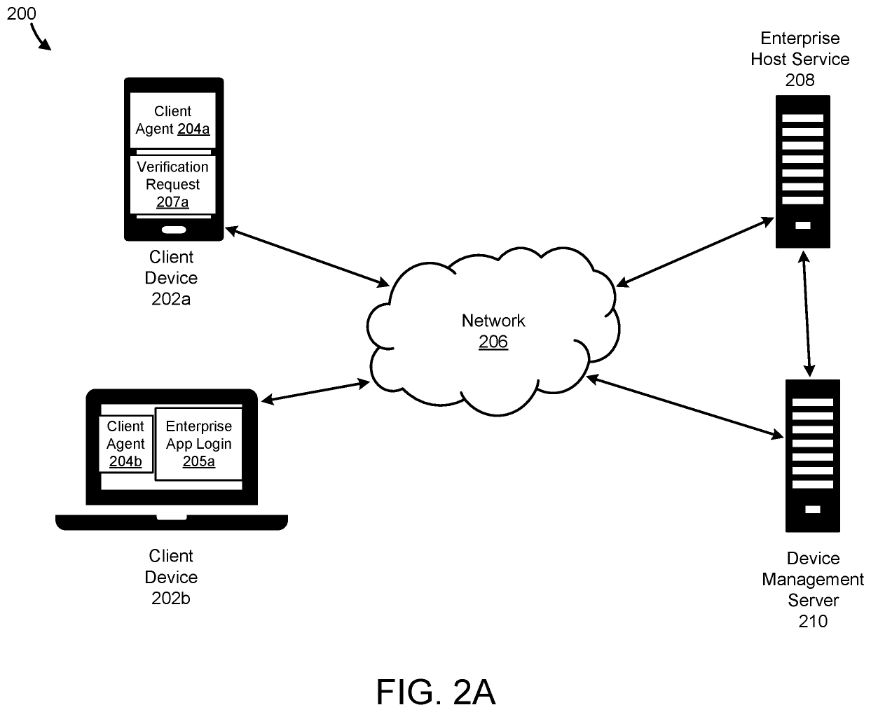

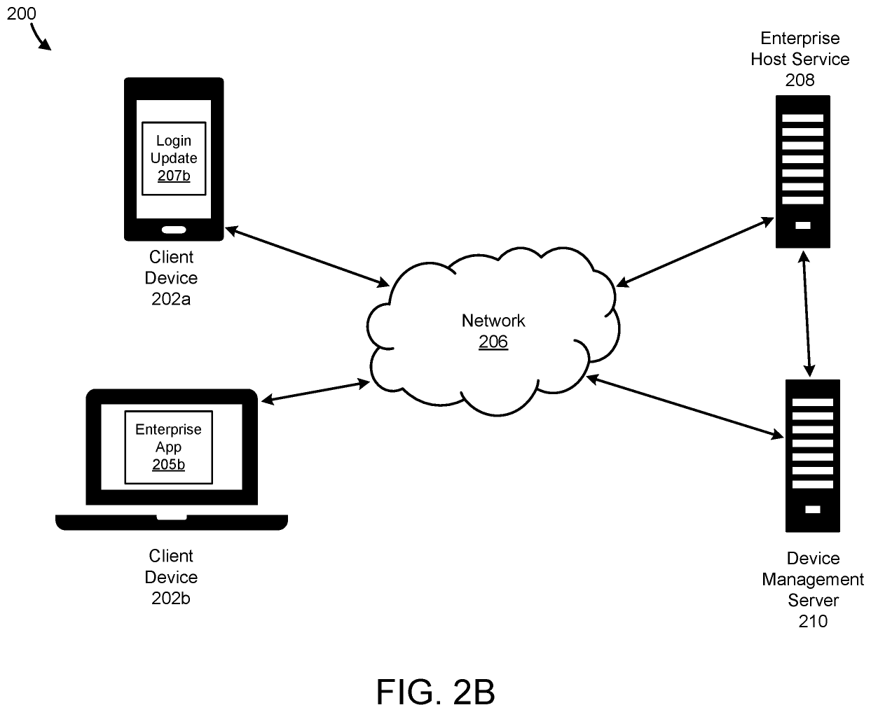

In a typical distributed workspace or remote resource system, providing secure access to each of the client devices 102a and 102b as shown in FIG. 1 would require two separate and distinct authentication processes for each device, even if each device is assigned to the same user. FIGS. 2A and 2B illustrate a system 200 in which a single sign-on technique as described herein is used to authenticate a user of multiple client devices belonging to or otherwise assigned to the user.

FIG. 2A illustrates a logical architecture of one implementation of, for example, a distributed workspace system 200 that is configured to connect one or more client devices with one or more remote computing devices configured to host one or more shared resources such as applications accessible via a distributed workspace. However, in contrast to system 100 as described above, system 200 is configured to provide an improved user experience during device authentication by using a single sign-on technique as described herein.

As shown in FIG. 2A, the system 200 can include a client device 202a and a client device 202b. In this example, each of the client devices 202a and 202b belong to or otherwise assigned to the same user. For example, as shown in FIG. 2A, client device 202a can be a user's cellphone and client device 202b can be the user's laptop computer.

As further shown in FIG. 2A, each of client devices 202a and 202b can include a client agent 204a and 204b respectively, herein collectively referred to as client agent 204. Client agent 204 can be configured to provide an interface to facilitate remote access to one or more resources hosted at, for example, a remote computing device such as an enterprise host service 208 and/or device management server 210. In certain implementations, the client devices 202a and 202b can be operably connected to the enterprise host service 208 and/or device management server 210 via one or more networks 206. In some examples, the network 206 can be a wired network, a wireless network, or a combination of both wired and wireless networks.

Upon first connecting to the enterprise host service 208 and/or device management server 210, a first client device such as client device 202a can provide authentication information. For example, the client agent 204a can receive username and password information from the user of client device 202a and transmit this information, along with any additional information such as authorization credential information stored on the client device 202a, to the device management server 210 via the network 206. The device management server 210 can receive the authorization information, authenticate a user of the client device 202a, and enroll the client device 202a as a trusted client device by providing, for example, an access token or another similar authentication token to the client device 202a for use in accessing one or more remotely located resources as described herein. In certain implementations, the client agent 204a can use the token to access one or more resources hosted at or otherwise made accessible by the enterprise host service 208 and/or device management server 210.

As described herein, the device management server 210 can be implemented as an MDM server that is configured to store essential information related to mobile devices and control access to remote resources by the mobile devices. For example, the MDM server can be configured to control which applications and other resources are accessible by the mobile devices, whether stored locally on the mobile devices or remotely accessed, as well as provide location and security services for the mobile devices. The MDM server can include management software that is configured to provide device management services as described herein.

As noted above, in certain situations a user may want to transition between or otherwise utilize multiple client devices to access similar remote resources. For example, the user of client device 202a may want to use client device 202b to access similar remote resources available at or made available by the enterprise host service 208 and/or device management server 210. In such a situation, rather than repeat the authentication process from the beginning as would traditionally be done, a single sign-on technique as described herein can be used. For example, as further shown in FIG. 2A, the user of client device 202b can access an enterprise application login 205a. Traditionally, the user can provide their username/password combination and login in using traditional authentication techniques. However, using the single sign-on techniques as described herein, the user can provide identification of a previously enrolled and trusted device associated with the user such as client device 202a. In such an example, the request to perform a single sign-on can be processed by the device management server 210 to verify the enrolled client device has been previously authenticated and to provide a single sign-on verification request to the enrolled client device, in this example client device 202a.

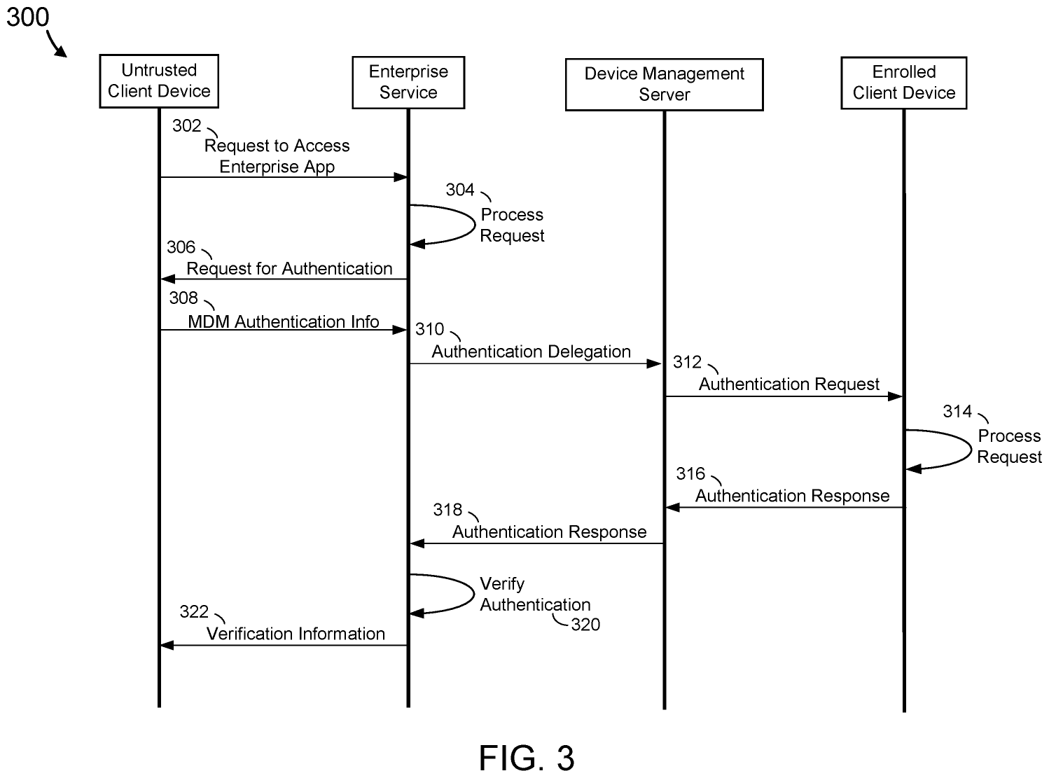

As shown in FIG. 2B, upon verification of the single sign-on request at the enrolled client device 202a, the user can access an enterprise application 205b on the client device 202b. In certain implementations, the enrolled client device 202a can receive, for example, a login update 207b indicating whether the single sign-on process has been successful or not. Additional detail of the actual single sign-on technique and device authentication is provided in the following discussion of FIGS. 3-6B.

It should be noted that two client devices 202a and 202b are shown in FIGS. 2A and 2B by way of example only. In some examples, additional client devices can be included and authenticated using the single sign-on technique as described herein. Similarly, the enterprise host service 208 and the device management server 210 are shown as separate remote computing devices by way of example only.

### Sample Implementation Processes

FIG. 3 illustrates a sample sequence diagram 300 of a process for authenticating an untrusted client computing device using a single sign-on technique as described herein. Diagram 300 as shown in FIG. 3 and described below is intended to provide an overview of the single sign-on techniques as described herein. As shown in the diagram 300, an untrusted client device such as client device 202b as described above in reference to FIGS. 2A and 2B can transmit 302 a request for access to one or more enterprise applications to an enterprise service such as enterprise host service 208 as described above in FIGS. 2A and 2B. The enterprise service can process 304 the request and provide 306 a response to the untrusted client device for authentication. To provide the benefits of the single sign-on techniques as described herein, the request for authentication can include an option for the user of the untrusted client device to provide an identifier of an enrolled client device to facilitate the single sign-on process. For example, the identifier can include a unique device name, a user identifier such as a username and/or email address, or another similar identifier that can be analyzed to identify a previously enrolled computing device associated with the user of the untrusted computing device as shown in FIG. 3. In certain implementations, the identifier can be configured to be processed by an MDM server such as a device management server (e.g., device management server 210 as shown in FIGS. 2A and 2B) to identify and locate the enrolled client device.

As further shown in FIG. 3, the untrusted client device can provide 308 MDM authentication information to the enterprise service, the MDM authentication information including, for example, the enrolled client device identifier. The enterprise service can receive the MDM authentication information and delegate 310 the authentication process to the device management server. The device management server can process the MDM authentication information to identify an enrolled client device associated with the user of the untrusted client device such as client device 202a as shown in FIGS. 2A and 2B and described above.

As further shown in FIG. 3, the device management server can transmit 312 an authentication request to the enrolled client device. The enrolled client device can process 314 the authentication request by, for example, confirming that the user has requested the single sign-on process as described herein and performing an authentication of the user of the enrolled client device. The enrolled client device can provide 316 an authentication response to the device management server. The device management server can provide 318 the authentication response to the enterprise service. The enterprise service can be configured to process the authentication response to verify 320 the authentication of the untrusted client device via the enrolled client device and provide 322 verification information to the untrusted client device about the results of the single sign-on process. If the process was successful, the enterprise service can grant the user of the untrusted client device access to the enterprise application. Conversely, if the process was unsuccessful, the enterprise service can block the user of the untrusted client device from access to the enterprise application and, in certain examples, provide an alternative method for user authentication.

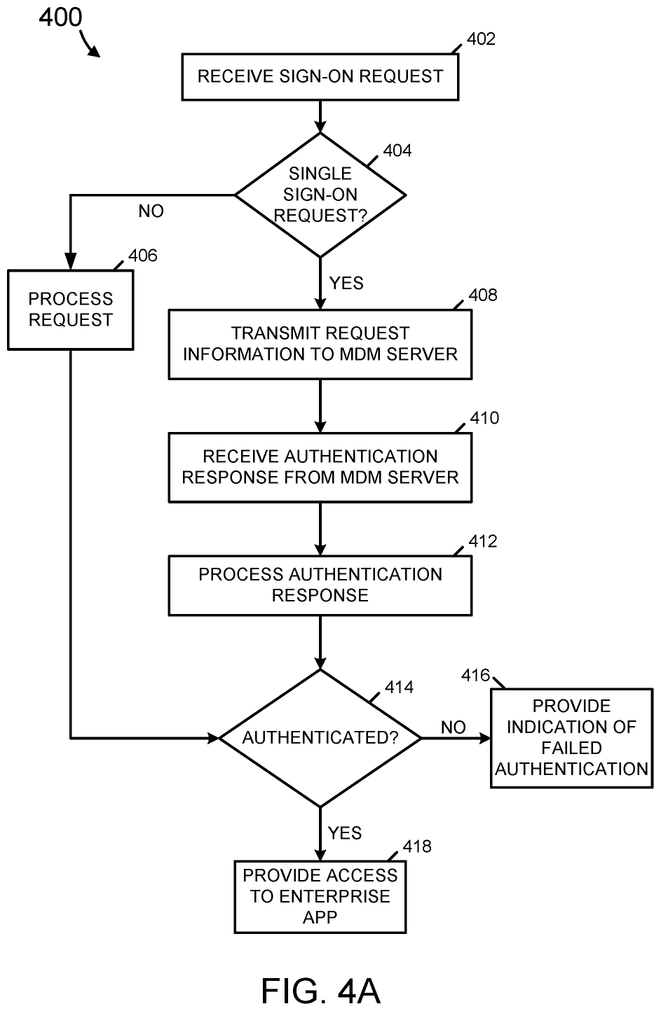

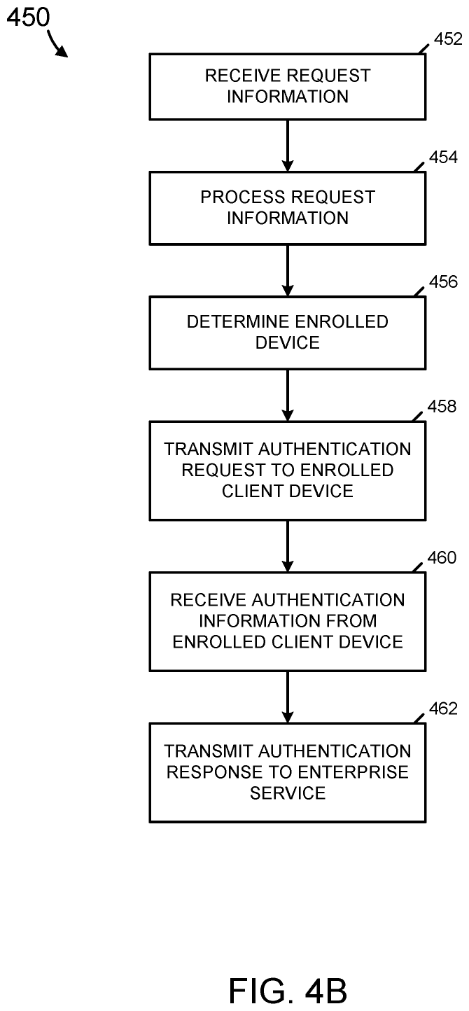

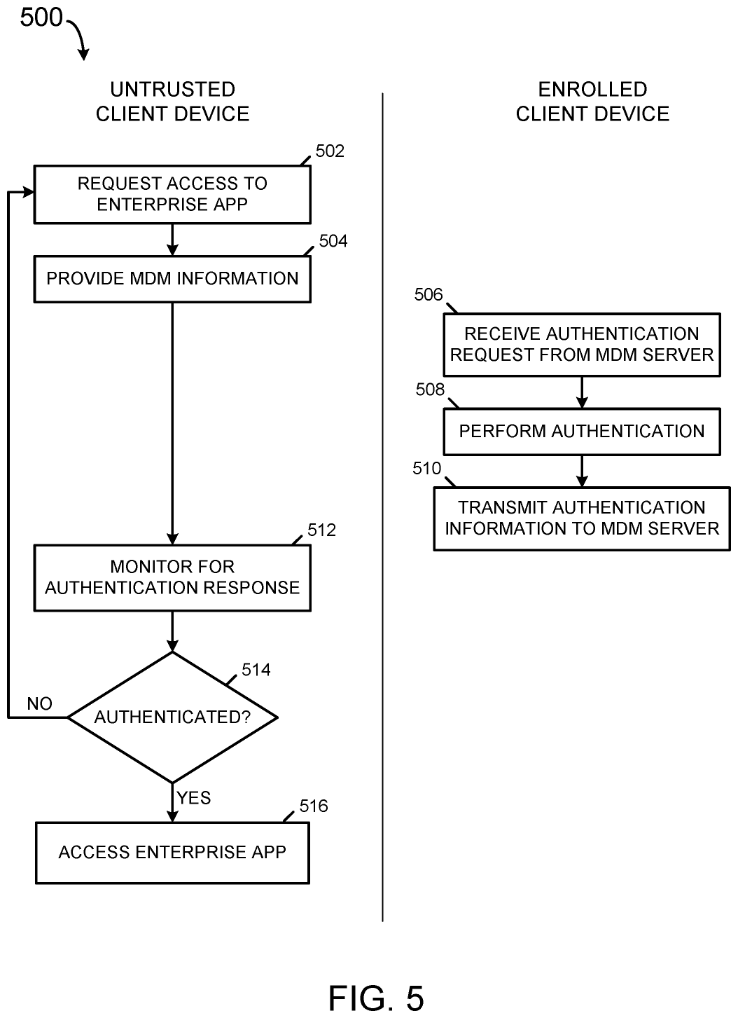

Additional detail of the process steps performed by the individual computing devices referenced in FIG. 3 is provided in the following discussions of FIGS. 4A and 4B and FIG. 5. For example, additional detail related to operation of the remote server is provided in the discussion of FIG. 4 below. Similarly, additional detail related to the operation of both client device 1 and client device 2 is provided in the discussion of FIG. 5 below.

It should be noted that the sequence as shown in diagram 300 is provided by way of example only. In some examples, the order of individual sequence steps can be altered and the device or process implementing an individual sequence step can be altered based upon the design and implementation of the single sign-on techniques and system as described herein.

FIG. 4 illustrates a sample process 400 for processing a single sign-on technique for two or more client computing devices owned by or otherwise assigned to the same user. The process 400 can be implemented, for example, by a processor (e.g., processor 702 as discussed below in reference to FIG. 7) of a remote computing device (e.g., remote computing device 206 as discussed above in reference to FIGS. 2A and 2B). Similarly, the process 400 can include additional detail for one or more process steps as performed by the remote server as described above in the discussion of diagram 300 in reference to FIG. 3.

Referring to FIG. 4A, a processor of, for example, a remote device configured to provide enterprise host services, can receive 402 a sign-on request for a client computing device such as an untrusted client device as described above to access one or more remote resources such as an enterprise application. The processor of the enterprise host services can determine 404 if the request is a single sign-on request. If the processor of the enterprise host services determines 404 that the request is not for a single sign-on, the processor can process 406 the request using traditional authentication techniques. Conversely, if the processor of the enterprise host services does determine 404 that the request is for a single sign-on, the processor can transmit 408 the request information to a processor of an MDM server. Additional detail on the processing of the request information by the processor of the MDM server is provided in the description of FIG. 4B below.

As further shown in FIG. 4A, the processor of the enterprise host services can receive 410 an authentication response from the processor of the MDM server. The processor of the enterprise host services can process 412 the authentication response to determine if, for example, the user of the untrusted client device is the same user as the user of the enrolled client device. For example, the processor of the enterprise host services can process the authentication response to determine and verify that the user of the untrusted client device is the user of the enrolled client device. In certain implementations, the processor of the enterprise host services can extract user identification information from the authentication response, the user identification providing information about the user of the enrolled client device. The processor of the enterprise host service can compare the user identification information against user identification information for the user of the untrusted client device. If the user identification information for the user of the enrolled device matches the user identification information for the user of the untrusted client device, the processor can thereby authenticate the user of the untrusted client device.

As further shown in FIG. 4A, if the processor of the enterprise host services determines 414 that the user of the untrusted client device is not the user of the enrolled client device, or is otherwise unauthorized to access the remote resource (e.g., lacks a proper security level to access the remote resource), the processor can provide 416 an indication of the failed authentication. Conversely, if the processor of the enterprise host services does determine that the user of the untrusted client device is the user of the enrolled client device and is authorized to access the remote resource, in this example an enterprise application, the processor can provide 418 access to the enterprise application via the untrusted client device.

FIG. 4B illustrates a sample process 450 for processing the authentication information by, for example, a processor of a remote computing device configured to perform management of mobile devices such as an MDM server as described herein. As shown in FIG. 4B, the processor of the MDM server can receive 452 the request information from the processor of the enterprise host service. The processor of the MDM server can process 454 the request information and determine 456 an enrolled client device as identified by the request information. For example, the processor of the MDM server can be configured to extract identifier information from the request information, the identifier information including one or more pieces of data that provide identification information about the enrolled client device. The processor of the MDM server can access one or more data structures such as an active directory of all users and associated enrolled mobile devices to identify additional information about the enrolled client device such as, for example, current connection information such as Internet protocol (IP) address and connection status. Based upon the determined 456 connection information, the processor of the MDM server can transmit 458 the authentication request to the enrolled client device.

As further shown in FIG. 4B, the processor of the MDM server can receive 460 authentication information from the enrolled client device. For example, the authentication information can include information related to the user of the enrolled client device such as biometrical authentication information as determined by the enrolled client device. Additional information about the authentication process as performed by the enrolled client device is provided in the discussion of FIG. 5 below.

The processor of the MDM server can further transmit 462 the authentication response to the processor of the enterprise host service for further processing as described above in the discussion of FIG. 4A.

As noted above, process 400 as shown in FIG. 4A and process 450 as shown in FIG. 4B can be implemented by a processor on a remote computing device. In some examples, an enterprise host service processor can be configured to implement process 400 as shown in FIG. 4A while an MDM processor can be configured to implement process 450 as shown in FIG. 4B. In certain implementations, the enterprise host service processor and the MDM processor can be implemented in separate remote computing devices configured to be operably connected such that information can be exchanged therebetween. In other examples, both the enterprise host service processor and the MDM processor can be implemented in the same remote computing device that is configured to provide both enterprise application access as well as management of mobile devices.

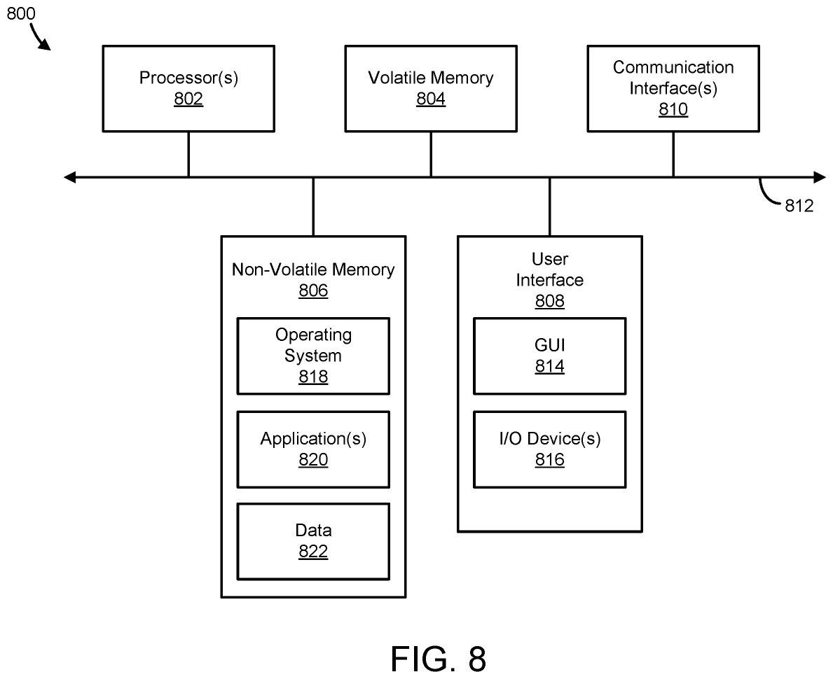

FIG. 5 illustrates a sample process 500 showing the client-side implementation of a single sign-on technique for two or more client computing devices owned by or otherwise assigned to the same user. Various acts of the process 500 can be implemented, for example, by a processor (e.g., processor 802 as discussed below in reference to FIG. 8) of a first client computing device (e.g., client device 202a as discussed above in reference to FIGS. 2A and 2B) as well as a second processor of a second client computing device (e.g., client computing device 202b as discussed above in reference to FIGS. 2A and 2B).

For example, as shown in FIG. 5, the processor of an untrusted client device can initially transmit 502 a sign-on request to a remote computing device such as an enterprise host service for authentication of a user of the untrusted client device. The processor of the untrusted client device can further provide 504 MDM authentication information to the enterprise host service. In certain implementations, the MDM authentication information can be included in the initial request to access the enterprise application. In other examples, the MDM authentication information can be provided in response to a request for additional information.

As described herein, and further shown in FIG. 5, the process 500 can transition to a processor of an enrolled client device. As shown, the processor of the enrolled client device can receive 506 an authentication request from an MDM service such as the device management servers as described herein. The processor of the enrolled client device can process the authentication request and perform 508 the authentication. For example, the processor of the enrolled client device can use one or more verification tools embedded or otherwise included in the enrolled client device to authenticate the user of the enrolled client device. For example, the enrolled client device can include one or more biometric authentication processes such as a fingerprint reader, facial recognition process (including, for example, eye feature identification such as iris identification), voice identification, and other similar biometric authentication processes. By utilizing an existing biometric authentication processor, the processor of the enrolled client device can perform 508 the authentication process with little additional input or effort form the user of the enrolled client device. Upon completion of the authentication, the processor of the enrolled client device can transmit 510 the authentication information to the MDM server for further processing as described above.

As further shown in FIG. 5, the process 500 can transition back to the processor of the untrusted client device. The processor of the untrusted client device can monitor 512 for an authentication response from, for example, the enterprise host service as described herein. The processor of the untrusted client device can determine 514 whether the user of the untrusted client device has been authenticated. If the user has not been authenticated, the processor of the untrusted client device can again transmit 502 a request for access to the enterprise application. Conversely, if the user has been authenticated, the processor of the untrusted client device can access 516 the enterprise application.

It should be noted that the sample processes as shown in FIGS. 4 and 4B and FIG. 5 are provided by way of example only. Depending upon the design and implementation of the single sign-on techniques as described herein, one or more processes or process steps as shown in FIGS. 4A, 4B, and/or 5 can be altered accordingly. For example, the processes as shown in FIGS. 4A and 4B and FIG. 5 can be repeated each time a user of an untrusted client device attempts to access a secured remote resource. In other examples, secured remote resources may be grouped together such that, once a user is authenticated and/or authorized to access one resource in the group (e.g., using the processes as shown in FIGS. 4A and 4B and FIG. 5), the user can access the additional resources in the group without additional authentication or authorization.

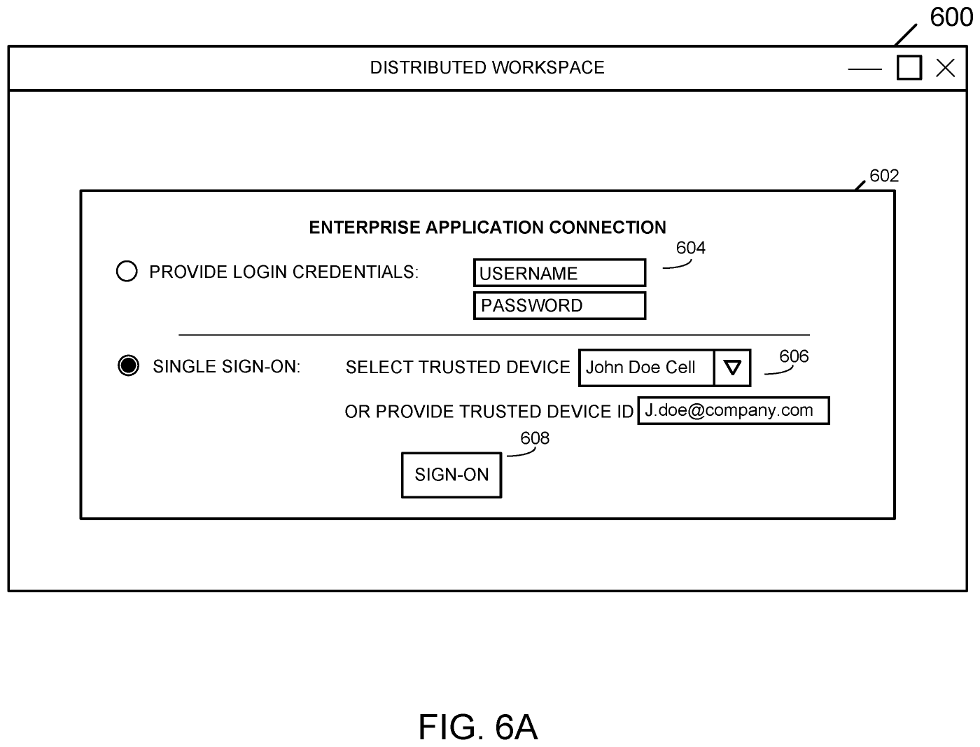

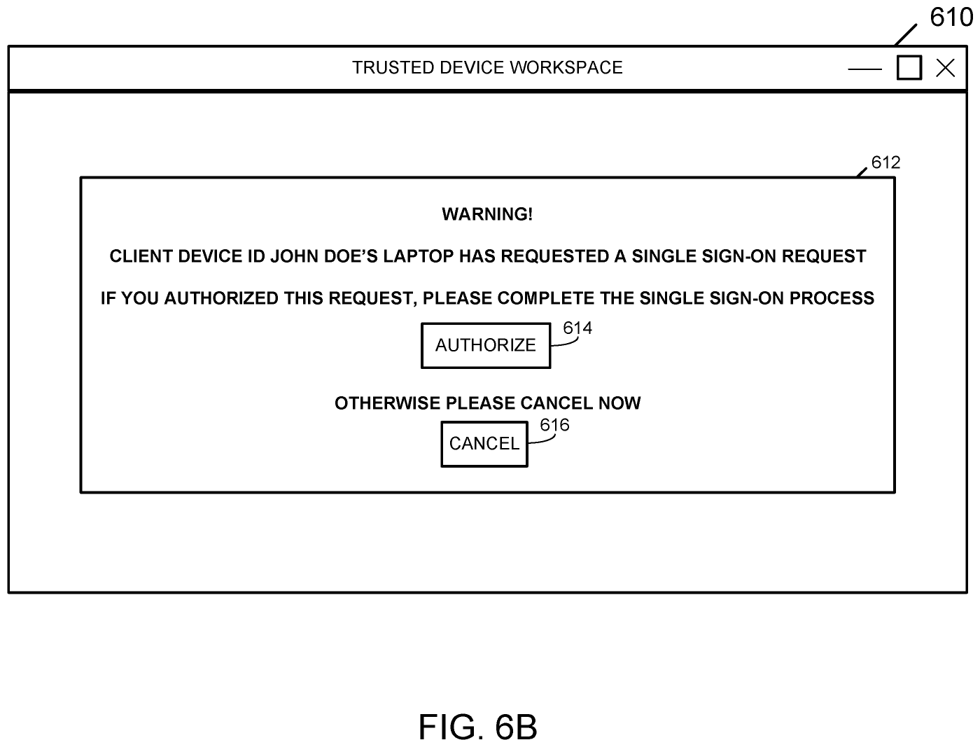

FIG. 6A illustrates a sample view of a user interface screen 600 that is displayed on an untrusted client computing device such as, for example, the client device 202b as described above and managed by a client agent such as, for example, client agent 204b. The client agent can be configured to manage access to remote resources hosted by, for example, enterprise host service 208 and/or device management server 210 as described above. As specifically shown in FIG. 6A, screen 600 illustrates a distributed workspace interface that includes information for processing a request for access to one or more enterprise applications using the single sign-on process as described herein. In such an example, user interface screen 600 can be configured to be displayed or otherwise presented to the user by the untrusted client device (e.g., client device 202b).

As illustrated in FIG. 6A, the screen 600 includes user interface controls 602, 604, and 606. In certain implementations, the control 602 can be configured to display text or other similar information to a user. For example, as shown in FIG. 6A, the control 602 can include an indication that additional information is requested to establish a connection to an enterprise application via an enterprise host service as described herein.

As further shown in FIG. 6A, control 602 can include the control 604. The control 604 can include an option for the user to provide traditional login information such as a username/password combination. For example, as shown in FIG. 6A, the control 604 can include text fields configured to receive user-provided text related to the username/password combination. As further shown in FIG. 6A, the control 602 can include the control 606. The control 606 can include an option for the user to provide single sign-on information such as MDM identification information as described herein. For example, the control 606 can include a drop down menu for providing an input to the user to select an existing device name. Additionally, the control 606 can include a text field for providing the user a manual input for providing identification information for an enrolled or otherwise trusted client device as described herein.

The control 606 can further include the control 608. The control 608 can provide the user with an input to affirmatively continue the sign-on process using, for example, the traditional login information as provided via the control 604 or with the single sign-on information provided via the control 606.

FIG. 6B illustrates a sample view of a user interface screen 610 that is displayed on an enrolled and trusted client computing device such as, for example, the client device 202a as described above and managed by a client agent such as, for example, client agent 204a. The client agent can be configured to manage access to remote resources hosted by, for example, enterprise host service 208 and/or device management server 210 as described above. As specifically shown in FIG. 6B, screen 610 illustrates a distributed workspace interface that includes a notice of a request for a single sign-on from another client computing device such as the untrusted client device as described above.

As illustrated in FIG. 6B, the screen 610 includes user interface controls 612, 614, and 616. In certain implementations, control 612 can be configured to display a text or other similarly displayed alert or warning to a user. For example, as shown in FIG. 6B, the control 612 can include an alert that another client computing device has requested a single sign-on request. The control can include specific information such as the requesting device name (e.g., John Doe's Laptop as shown in FIG. 6B) as well as login in session information received from, for example, the second computing device (e.g., client device 202b as described above).

As further shown in FIG. 6B, control 614 and control 616 can include options for the user to authorize or otherwise accept the single sign-on request or to cancel the single sign-on request. For example, if the user has requested the single sign-on request for a second user device, the control 614 can receive a user selection of the “Authorize” option, thereby confirming the single sign-on request. Conversely, if the user has not requested the single sign-on request or has otherwise changed their mind about the request, the control 616 can receive a user selection of the “Cancel” option, thereby canceling the single sign-on request.

### Hardware Implementation Examples

FIG. 7 depicts an illustrative enterprise mobility management system 700 that can include, for example, one or more of an enterprise host service (e.g., enterprise host service 208) and an MDM server (e.g., device management server 210) as a combined gateway server 706 as described below. As shown in FIG. 7, the left hand side represents an enrolled mobile device 702 with a client agent 704, which interacts with gateway server 706 (which includes Access Gateway and application controller functionality) to access various enterprise resources 708 and services 709 such as Exchange, Sharepoint, public-key infrastructure (PKI) Resources, Kerberos Resources, Certificate Issuance service, as shown on the right hand side above. Although not specifically shown, the mobile device 702 may also interact with an enterprise application store (StoreFront) for the selection and downloading of applications.

The client agent 704 acts as the UI (user interface) intermediary for Windows apps/desktops hosted in an Enterprise data center, which are accessed using the High-Definition User Experience (HDX)/ICA display remoting protocol. The client agent 704 also supports the installation and management of native applications on the mobile device 702, such as native iOS or Android applications. For example, the managed applications 710 (mail, browser, wrapped application) shown in the figure above are all native applications that execute locally on the mobile device 702. Client agent 704 and application management framework of this architecture act to provide policy driven management capabilities and features such as connectivity and single sign-onto enterprise resources/services 708. The client agent 704 handles primary user authentication to the enterprise, normally to Access Gateway (AG) 706 with single sign-on to other gateway server components. The client agent 704 obtains policies from gateway server 706 to control the behavior of the managed applications 710 on the mobile device 702.

The Secure InterProcess Communication (IPC) links 712 between the native applications 710 and client agent 704 represent a management channel, which may allow a client agent to supply policies to be enforced by the application management framework 714 “wrapping” each application. The IPC channel 712 may also allow client agent 704 to supply credential and authentication information that enables connectivity and single sign-on to enterprise resources 708. Finally, the IPC channel 712 may allow the application management framework 714 to invoke user interface functions implemented by client agent 704, such as online and offline authentication.

Communications between the client agent 704 and gateway server 706 are essentially an extension of the management channel from the application management framework 714 wrapping each native managed application 710. The application management framework 714 may request policy information from client agent 704, which in turn may request it from gateway server 706. The application management framework 714 may request authentication, and client agent 704 may log into the gateway services part of gateway server 706 (for example, Citrix Gateway). Client agent 704 may also call supporting services on gateway server 706, which may produce input material to derive encryption keys for the local data vaults 716, or may provide client certificates which may enable direct authentication to PKI protected resources, as more fully explained below.

In more detail, the application management framework 714 “wraps” each managed application 710. This may be incorporated via an explicit build step, or via a post-build processing step. The application management framework 714 may “pair” with client agent 704 on first launch of an application 710 to initialize the Secure IPC channel 712 and obtain the policy for that application. The application management framework 714 may enforce relevant portions of the policy that apply locally, such as the client agent login dependencies and some of the containment policies that restrict how local operating system services may be used, or how they may interact with the managed application 710.

The application management framework 714 may use services provided by client agent 704 over the Secure IPC channel 712 to facilitate authentication and internal network access. Key management for the private and shared data vaults 716 (containers) may be also managed by appropriate interactions between the managed applications 710 and client agent 704. Vaults 716 may be available only after online authentication or may be made available after offline authentication if allowed by policy. First use of vaults 716 may require online authentication, and offline access may be limited to at most the policy refresh period before online authentication is again required.

Network access to internal resources may occur directly from individual managed applications 710 through Access Gateway 706. The application management framework 714 may be responsible for orchestrating the network access on behalf of each managed application 710. Client agent 704 may facilitate these network connections by providing suitable time limited secondary credentials obtained following online authentication. Multiple modes of network connection may be used, such as reverse web proxy connections and end-to-end virtual private network (VPN) style tunnels 718.

The Mail and Browser managed applications 710 have special status and may make use of facilities that might not be generally available to arbitrary wrapped applications. For example, the Mail application 710 may use a special background network access mechanism that allows it to access an Exchange server 708 over an extended period of time without requiring a full AG logon. The Browser application 710 may use multiple private data vaults 716 to segregate different kinds of data.

This architecture may support the incorporation of various other security features. For example, gateway server 706 (including its gateway services) in some cases may not need to validate active directory (AD) passwords. It can be left to the discretion of an enterprise whether an AD password may be used as an authentication factor for some users in some situations. Different authentication methods may be used if a user is online or offline (i.e., connected or not connected to a network).

Step up authentication is a feature wherein gateway server 706 may identify managed native applications 710 that are allowed to have access to highly classified data requiring strong authentication, and ensure that access to these applications is only permitted after performing appropriate authentication, even if this means a re-authentication is required by the user after a prior weaker level of login.

A security feature of system 700 can include encryption of the data vaults 716 (containers) on the mobile device 702. The vaults 716 may be encrypted so that all on-device data including files, databases, and configurations are protected. For on-line vaults, the keys may be stored on the server (gateway server 706), and for off-line vaults, a local copy of the keys may be protected by a user password or biometric validation. If or when data is stored locally on the mobile device 702 in the secure container 716, it may be preferred that a minimum of AES 256 encryption be utilized.

Other secure container features may also be implemented. For example, a logging feature may be included, wherein security events happening inside a managed application 710 may be logged and reported to the backend. Data wiping may be supported, such as if or when the managed application 710 detects tampering, associated encryption keys may be written over with random data, leaving no hint on the file system that user data was destroyed. Screenshot protection may be another feature, where an application may prevent any data from being stored in screenshots. For example, the key window's hidden property may be set to YES. This may cause whatever content is currently displayed on the screen to be hidden, resulting in a blank screenshot where any content would normally reside.

Another security feature may relate to the use of an OTP (one time password) 720 without the use of an AD (active directory) 722 password for access to one or more applications. In some cases, some users do not know (or are not permitted to know) their AD password, so these users may authenticate using an OTP 720 such as by using a hardware OTP system like SecurID (OTPs may be provided by different vendors also, such as Entrust or Gemalto). In some cases, after a user authenticates with a user ID, a text may be sent to the user with an OTP 720. In some cases, this may be implemented only for online use, with a prompt being a single field.

An offline password may be implemented for offline authentication for those managed applications 710 for which offline use is permitted via enterprise policy. For example, an enterprise may want StoreFront to be accessed in this manner. In this case, the client agent 704 may require the user to set a custom offline password and the AD password is not used. Gateway server 706 may provide policies to control and enforce password standards with respect to the minimum length, character class composition, and age of passwords, such as described by the standard Windows Server password complexity requirements, although these requirements may be modified.

Another feature may relate to the enablement of a client side certificate for certain applications 710 as secondary credentials (for the purpose of accessing PKI protected web resources via the application management framework micro VPN feature). For example, a managed application 710 may utilize such a certificate. In this case, certificate-based authentication using ActiveSync protocol may be supported, wherein a certificate from the client agent 704 may be retrieved by gateway server 706 and used in a keychain. Each managed application 710 may have one associated client certificate, identified by a label that is defined in gateway server 706.

Gateway server 706 may interact with an enterprise special purpose web service to support the issuance of client certificates to allow relevant managed applications to authenticate to internal PKI protected resources.

The client agent 704 and the application management framework 714 may be enhanced to support obtaining and using client certificates for authentication to internal PKI protected network resources. More than one certificate may be supported, such as to match various levels of security and/or separation requirements. The certificates may be used by the Mail and Browser managed applications 710, and ultimately by arbitrary wrapped applications 710 (provided those applications use web service style communication patterns where it is reasonable for the application management framework to mediate secure hypertext transfer protocol (HTTPS) requests).

Application management client certificate support on iOS may rely on importing a public-key cryptography standards (PKCS) 12 BLOB (Binary Large Object) into the iOS keychain in each managed application 710 for each period of use. Application management framework client certificate support may use a HTTPS implementation with private in-memory key storage. The client certificate may not be present in the iOS keychain and may not be persisted except potentially in “online-only” data value that is strongly protected.

Mutual secure socket layer (SSL) or transport layer security (TLS) may also be implemented to provide additional security by requiring that a mobile device 702 is authenticated to the enterprise, and vice versa. Virtual smart cards for authentication to gateway server 706 may also be implemented.

Another feature may relate to application container locking and wiping, which may automatically occur upon jail-break or rooting detections, and occur as a pushed command from administration console, and may include a remote wipe functionality even when a managed application 710 is not running.

A multi-site architecture or configuration of enterprise application store and an application controller may be supported that allows users to be serviced from one of several different locations in case of failure.

In some cases, managed applications 710 may be allowed to access a certificate and private key via an API (for example, OpenSSL). Trusted managed applications 710 of an enterprise may be allowed to perform specific Public Key operations with an application's client certificate and private key. Various use cases may be identified and treated accordingly, such as if or when an application behaves like a browser and no certificate access is required, if or when an application reads a certificate for “who am I,” if or when an application uses the certificate to build a secure session token, and if or when an application uses private keys for digital signing of important data (e.g. transaction log) or for temporary data encryption.

FIG. 8 depicts a block diagram of a computing device 800 useful for practicing an example of client devices 202a and 202b, enterprise host service 208, and/or device management server 208 as described above. The computing device 800 includes one or more processors 802, volatile memory 804 (e.g., random access memory (RAM)), non-volatile memory 806, user interface (UI) 808, one or more communications interfaces 810, and a communications bus 812. One or more of the computing devices 800 can also be referred to as a computer system.

The non-volatile memory 806 can include: one or more hard disk drives (HDDs) or other magnetic or optical storage media; one or more solid state drives (SSDs), such as a flash drive or other solid-state storage media; one or more hybrid magnetic and solid-state drives; and/or one or more virtual storage volumes, such as a cloud storage, or a combination of such physical storage volumes and virtual storage volumes or arrays thereof.

The user interface 808 can include a graphical user interface (GUI) 814 (e.g., a touchscreen, a display, etc.) and one or more input/output (I/O) devices 816 (e.g., a mouse, a keyboard, a microphone, one or more speakers, one or more cameras, one or more biometric scanners, one or more environmental sensors, and one or more accelerometers, etc.).

The non-volatile memory 806 can store an operating system 818, one or more applications 820, and data 822 such that, for example, computer instructions of the operating system 818 and/or the applications 820 are executed by processor(s) 802 out of the volatile memory 804. In some examples, the volatile memory 804 can include one or more types of RAM and/or a cache memory that can offer a faster response time than a main memory. Data can be entered using an input device of the GUI 814 or received from the I/O device(s) 816. Various elements of the computing device 800 can communicate via the communications bus 812.

The illustrated computing device 800 is shown merely as an example client device or server and can be implemented by any computing or processing environment with any type of machine or set of machines that can have suitable hardware and/or software capable of operating as described herein.

The processor(s) 802 can be implemented by one or more programmable processors to execute one or more executable instructions, such as a computer program, to perform the functions of the system. As used herein, the term “processor” describes circuitry that performs a function, an operation, or a sequence of operations. The function, operation, or sequence of operations can be hard coded into the circuitry or soft coded by way of instructions held in a memory device and executed by the circuitry. A processor can perform the function, operation, or sequence of operations using digital values and/or using analog signals.

In some examples, the processor can be embodied in one or more application specific integrated circuits (ASICs), microprocessors, digital signal processors (DSPs), graphics processing units (GPUs), microcontrollers, field programmable gate arrays (FPGAs), programmable logic arrays (PLAs), multicore processors, or general-purpose computers with associated memory.

The processor 802 can be analog, digital or mixed. In some examples, the processor 802 can include multiple processor cores and/or multiple processors configured to provide functionality for parallel, simultaneous execution of instructions or for parallel, simultaneous execution of one instruction on more than one piece of data.

The communications interfaces 810 can include one or more interfaces to enable the computing device 800 to access a computer network such as a Local Area Network (LAN), a Wide Area Network (WAN), a Personal Area Network (PAN), or the Internet through a variety of wired and/or wireless connections, including cellular connections.

In described examples, the computing device 800 can execute an application on behalf of a user of a client device (e.g., one or both of client devices 202a and 202b as shown in FIGS. 2A and 2B and described above). For example, the computing device 800 can execute one or more virtual machines managed by a hypervisor and accessed via, for example, a client agent (e.g., client agent software 704 as shown in FIG. 7 and described above). Each virtual machine can provide an execution session within which applications execute on behalf of a user or a client device, such as a hosted desktop session. The computing device 800 can also execute a terminal services session to provide a distributed workspace environment. The computing device 800 can provide access to a remote computing environment including one or more applications, one or more desktop applications, and one or more desktop sessions in which one or more applications can execute.

Having thus described several aspects of at least one example, it is to be appreciated that various alterations, modifications, and improvements will readily occur to those skilled in the art. For instance, examples disclosed herein can also be used in other contexts. Such alterations, modifications, and improvements are intended to be part of this disclosure and are intended to be within the scope of the examples discussed herein. Accordingly, the foregoing description and drawings are by way of example only.

Also, the phraseology and terminology used herein is for the purpose of description and should not be regarded as limiting. Any references to examples, components, elements or acts of the systems and methods herein referred to in the singular can also embrace examples including a plurality, and any references in plural to any example, component, element or act herein can also embrace examples including only a singularity. References in the singular or plural form are not intended to limit the presently disclosed systems or methods, their components, acts, or elements. The use herein of “including,” “comprising,” “having,” “containing,” “involving,” and variations thereof is meant to encompass the items listed thereafter and equivalents thereof as well as additional items. References to “or” can be construed as inclusive so that any terms described using “or” can indicate any of a single, more than one, and all of the described terms. In addition, in the event of inconsistent usages of terms between this document and documents incorporated herein by reference, the term usage in the incorporated references is supplementary to that of this document; for irreconcilable inconsistencies, the term usage in this document controls.

What is claimed is:

1. A computer system for providing a single sign-on for authenticating a user via multiple client devices in a distributed resource environment, the system comprising:
a memory;
a network interface; and
at least one processor coupled to the memory and the network interface and being configured to
receive, via the network interface, a first request to connect to a remote resource from an untrusted client device,
process the first request to identify an enrolled client device that is configured to authenticate a user of the untrusted client device,
verify that a user of the enrolled client device is the user of the untrusted client device, and
provide the untrusted client device access to the remote resource.

2. The computer system of claim 1, wherein to verify whether the user of the enrolled client device is the user of the untrusted client device comprises the at least one processor being further configured to:
identify mobile device management (MDM) device identification information for the enrolled client device received in the first request;
transmit the MDM device identification information to an MDM processor for processing;
receive authentication information from the MDM processor, the authentication information comprising information about the user of the enrolled client device; and
verify whether a user of the enrolled client device is the user of the untrusted client device based upon the authentication information.

3. The computer system of claim 2, wherein to verify whether a user of the enrolled client device is the user of the untrusted client device based upon the authentication information comprises the at least one processor being further configured to:
extract user identification information for the user of the enrolled client device from the authentication information;
compare the user identification information for the user of the enrolled client device against user identification information for the user of the untrusted client device; and
determine if the user identification information for the user of the enrolled client device matches the user identification information for the user of the untrusted client device.

4. The computer system of claim 2, further comprising the MDM processor, the MDM processor being configured to:
receive the MDM device identification information from the at least one processor;
identify the enrolled client device based upon the MDM device identification information;
verify the user of the enrolled client device; and
transmit the authentication information to the at least one processor based upon verification of the user of the enrolled client device.

5. The computer system of claim 4, wherein to verify the user of the enrolled client device comprises the MDM processor being further configured to:
transmit an authentication request to the enrolled client device;
receive an authentication response from the enrolled client device; and
verify the user of the enrolled client based upon the authentication response.

6. The computer system of claim 5, wherein the authentication response is based upon a biometric authentication process of the user of the enrolled client device performed by the enrolled client device.

7. The computer system of claim 1, wherein the first request comprises single sign-on information including an identifier of the enrolled client device.

8. A method of providing a single sign-on for authenticating a user via multiple client devices in a distributed resource environment, the method comprising:
receiving, by at least one processor, a first request to connect to a remote resource from an untrusted client device;
processing, by the at least one processor, the first request to identify an enrolled client device configured to authenticate a user of the untrusted client device;
verifying, by the at least one processor, that a user of the enrolled client device is the user of the untrusted client device; and
providing, by the at least one processor, the untrusted client device access to the remote resource.

9. The method of claim 8, wherein verifying whether the user of the enrolled client device is the user of the untrusted client device comprises:
identifying, by the at least one processor, mobile device management (MDM) device identification information for the enrolled client device received in the first request;
transmitting, by the at least one processor, the MDM device identification information to an MDM processor for processing;
receiving, by the at least one processor, authentication information from the MDM processor comprising information about the user of the enrolled client device; and
verifying, by the at least one processor, whether a user of the enrolled client device is the user of the untrusted client device based upon the authentication information.

10. The method of claim 9, wherein verifying whether a user of the enrolled client device is the user of the untrusted client device based upon the authentication information comprises:
extracting, by the at least one processor, user identification information for the user of the enrolled client device from the authentication information;
comparing, by the at least one processor, the user identification information for the user of the enrolled client device against user identification information for the user of the untrusted client device; and
determining, by the at least one processor, if the user identification information for the user of the enrolled client device matches the user identification information for the user of the untrusted client device.

11. The method of claim 9, further comprising:
receiving, by an MDM processor operably coupled to the at least one processor, the MDM device identification information from the at least one processor;
identifying, by the MDM processor, the enrolled client device based upon the MDM device identification information;
verifying, by the MDM processor, the user of the enrolled client device; and
transmitting, by the MDM processor, the authentication information to the at least one processor based upon verification of the user of the enrolled client device.

12. The method of claim 11, wherein verifying the user of the enrolled client device comprises:
transmitting, by the MDM processor, an authentication request to the enrolled client device;
receiving, by the MDM processor, an authentication response from the enrolled client device; and
verifying, by the MDM processor, the user of the enrolled client based upon the authentication response.

13. The method of claim 12, wherein the authentication response is based upon a biometric authentication process of the user of the enrolled client device performed by the enrolled client device.

14. The method of claim 8, wherein the first request comprises single sign-on information including an identifier of the enrolled client device.

15. A computer system for providing a single sign-on for authenticating a user via multiple client devices in a distributed resource environment, the system comprising:
an untrusted client device configured to execute a first client agent for authenticating the user of the untrusted client device;
an enrolled client device configured to execute a second client agent for authenticating the user of the enrolled client device; and
a remote computing device comprising
a memory,
a network interface configured to communicate with the untrusted client device and the enrolled client device, and
at least one processor coupled to the memory and the network interface and configured to
receive a first request to a remote resource from the untrusted client device,
process the first request to identify the enrolled client device that is configured to authenticate a user of the untrusted client device,
query the enrolled client device to verify whether a user of the enrolled client device is the user of the untrusted client device, and
if the user of the untrusted client device is authorized to access the remote resource, provide the untrusted client device access to the remote resource.

16. The computer system of claim 15, wherein to query the enrolled client device to verify whether a user of the enrolled client device is the user of the untrusted client device comprises the at least one processor being further configured to:
identify mobile device management (MDM) device identification information for the enrolled client device received in the first request;
transmit the MDM device identification information to an MDM processor for processing;
receive authentication information from the MDM processor comprising information about the user of the enrolled client device; and
verify whether a user of the enrolled client device is the user of the untrusted client device based upon the authentication information.

17. The computer system of claim 16, wherein to verify whether a user of the enrolled client device is the user of the untrusted client device based upon the authentication information comprises the at least one processor being further configured to:
extract user identification information for the user of the enrolled client device from the authentication information;
compare the user identification information for the user of the enrolled client device against user identification information for the user of the untrusted client device; and
determine if the user identification information for the user of the enrolled client device matches the user identification information for the user of the untrusted client device.

18. The computer system of claim 16, further comprising the MDM processor, the MDM processor being configured to:
receive the MDM device identification information from the at least one processor;
identify the enrolled client device based upon the MDM device identification information;
verify the user of the enrolled client device; and
transmit the authentication information to the at least one processor based upon verification of the user of the enrolled client device.

19. The computer system of claim 18, wherein to verify the user of the enrolled client device comprises the MDM processor being further configured to:
transmit an authentication request to the enrolled client device;
receive an authentication response from the enrolled client device; and
verify the user of the enrolled client based upon the authentication response.

20. The computer system of claim 19, wherein the authentication response is based upon a biometric authentication process of the user of the enrolled client device performed by the enrolled client device.
